(19) United States
(12) Patent Application Publication
(10) Pub. No.: US 2020/0379105 A1
(43) Pub. Date: Dec. 3, 2020

(54) ROBUST AND ACCURATE CLOSE RANGE DETECTION FOR ULTRANSONIC LEVEL MEASUREMENT

(71) Applicant: Siemens Aktiengesellschaft, München (DE)

(72) Inventor: Jing Liu, Peterborough (CA)

(21) Appl. No.: 16/604,695

(22) PCT Filed: Apr. 12, 2017
(86) PCT No.: PCT/US2017/027095

§ 371 Date: Oct. 11, 2019

(51) Int. Cl. G01S 15/10

(52) U.S. Cl. CPC G01S 15/101

(57) ABSTRACT

A pulse-echo ranging system (100) and method that processes the reflected signal amplitude profile (9) to determine an accurate and robust distance to a target (16). The method uses the energy decay trend (15) of the reflected signals (13) in order to avoid environmental factors that can degrade the clarity of the reflected signals (13). Results of the computations that use the energy decay trend (15) are then applied to reflected signal amplitude profile (9) in order to obtain an accurate distance to target (16).

### BACKGROUND

### 1. Field

Disclosed embodiments are generally related to pulse-echo ranging and, more particularly, to a method for detecting a reflected signal.

### 2. Description of the Related Art

Pulse-echo ranging systems, or time-of-flight ranging systems, are used in level measurement applications to determine the distance to a reflective surface of a material, such as liquid, slurry or solid, by measuring how long after transmission of a pulse of energy it takes to receive the reflected signal (i.e. the echo).

Acoustic pulse-echo ranging systems generally include a transceiver and a signal processor. The transceiver serves the dual role of transmitting pulses and receiving the reflected signals. A profile is generated from the received signals. A reflected signal is identified in the profile by the signal processor, and the distance or range of the target is calculated based on the propagation time of the reflected signal.

Close in range measurement of a level target can be difficult using a pulse echo ranging system. This is due to interference issues that occur when close to the target. These interference issues create strong energies that are visible in the signal profile, which is generally known as “ringing down”. The interference may be coming from a number of sources such as the strength of near reflections from the measuring system and dispersion within the pulse-echo ranging system's transmission path. Preferably the impact of “ringing down” when doing close in range measurement can be avoided.

### SUMMARY

Briefly described, aspects of the present disclosure relate to providing a method of detecting the reflected signal by using the energy decay of the reflected signal rather than only the peak of a signal to provide distance between an apparatus and a target.

An aspect of present disclosure may be a method for determining distance between an apparatus and a target. The method involves transmitting signals to the target from a transmitter of the apparatus; receiving reflected signals at a receiver of the apparatus, forming a reflected signal amplitude profile from the reflected signals; determining from the reflected signal amplitude profile an energy decay trend; obtaining a signature of a first reflected signal, wherein the signature of the first reflected signal is determined using the energy decay trend; locating a second reflected signal using the signature of the first reflected signal; and determining a first distance to the target by using a peak distance between a first determined peak and a second determined peak on the reflected signal amplitude profile.

Another aspect of the present disclosure may be an apparatus for determining distance to a target. The apparatus may comprise a transmitter for transmitting signals to the target; a receiver for receiving reflected signals; and a processor configured to determine from the reflected signals a reflected signal amplitude profile; wherein the processor determines an energy decay trend from the reflected signal amplitude profile; wherein the processor obtains a signature of a first reflected signal, wherein the signature of the first reflected signal is determined using the energy decay trend; wherein the processor locates a second reflected signal using the signature of the first reflected signal; wherein the processor determines a first distance to the target by using a peak distance between a first determined peak and a second determined peak.

Still yet another aspect of the present disclosure may be a method for determining distance between an apparatus and a target. The method may comprise transmitting signals to the target from a transmitter of the apparatus; receiving reflected signals at a receiver of the apparatus, forming a reflected signal amplitude profile from the reflected signals; determining an energy decay trend of the first reflected signal from the reflected signal amplitude profile; obtaining a signature of a first reflected signal, wherein the signature of the first reflected signal is determined using the energy decay trend; locating a second reflected signal using the signature of the first signal; determining a first distance to the target by using a peak distance between a first determined peak and a second determined peak; determining a multiplier factor for the first reflected signal using the determined first distance to the target; and applying the determined multiplier factor to the first reflected signal peak to obtain a second distance to the target.

### BRIEF DESCRIPTION OF THE DRAWINGS

FIG. 1 shows a diagram schematically illustrating a pulse-echo ranging system.

FIG. 2 is a flow chart of a method for determining the distance to a target.

FIG. 3 shows a reflective signal amplitude profile of the received reflected signals.

FIG. 4 shows a reflective signal amplitude profile of the received reflected signals with the trend of the energy decay illustrated.

FIG. 5 is a close up view of the reflected signal amplitude profile and trend illustrated in FIG. 4.

FIG. 6 is a diagram illustrating the signals transmitted and reflected from a target.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

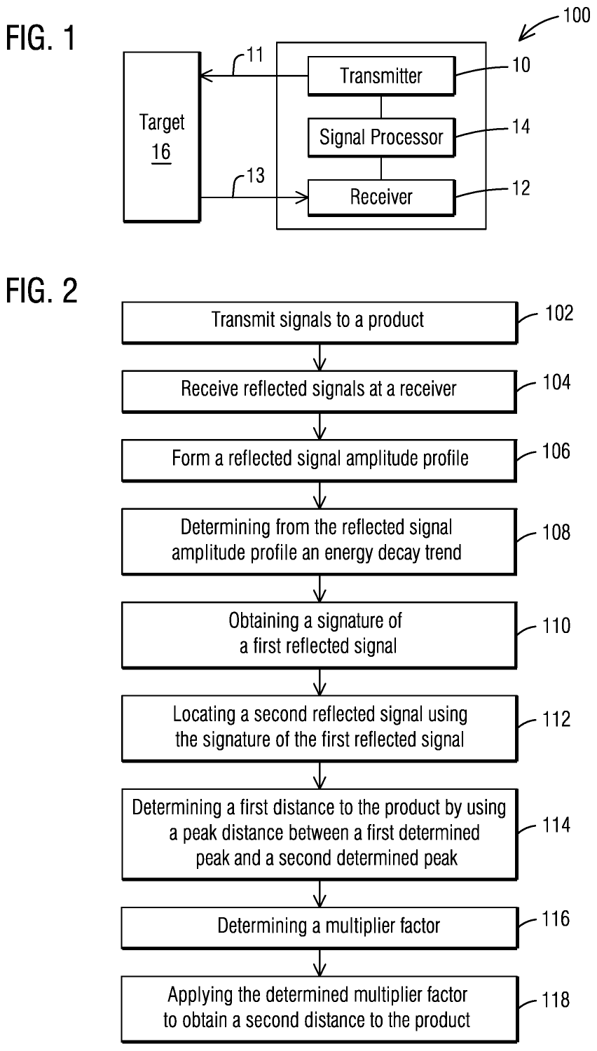

Referring to FIG. 1, an apparatus commonly referred to as a pulse-echo ranging system 100 uses ultrasonic, radar or microwave pulses and can include a transmitter 10 for transmitting signals 11 (i.e. pulses), a receiver 12 for receiving reflected signals 13 (i.e. echoes) of the energy signals 11 and a signal processor 14 for detecting and calculating the distance to the surface of a material 16 based on the analysis of the reflected signals 13. The distance is calculated based on the travel times of the transmitted signals 11 and the reflected signals 13. The transmitter 10 and receiver 12 may be housed in a single unit (i.e. a transceiver). In the embodiment discussed herein the transmitted signals are ultrasonic signals.

The transmitter 10 and receiver 12 are operably connected to a signal processor 14. The signal processor 14 may be one of many signal processors 14 that are able to take and analyse the reflected signals 13.

The signal processor 14 takes the reflected signals 13 and can form a reflected signal amplitude profile 9, also known as an echo amplitude profile. The reflected signal amplitude profile 9 represents the received reflected signal amplitudes as a function of their respective travel times. Each value of the reflected signal amplitude profile 9 corresponds to the amplitude of a reflected signal at a certain distance from the transmitter 10 and receiver 12.

Typically reflected signal detection focuses on the detection of the peaks of the reflected signals 13. Generally the reflected signals 13 have a concave (down facing) parabolic shape. When a target (i.e. product to be measured) is close the shape of the reflected signals 13 can become distorted. The reflected signals 13 may lose their parabolic shape and might have several small peaks instead of a single strong peak. This can make it difficult to detect the first peak of the reflected signals 13 in the reflected signal amplitude profile 9. Difficulty in detecting the first peak makes it difficult to determine the distance to the target 16. Furthermore, due to the effects of ringing down the first peak detected may not be the actual first peak since as the distance of the target 16 gets closer to the transmitter 10 interference makes it difficult to detect the actual first peak. The first true reflected signal is obscured by the effects of ringing down, and the reflected signal 13 shown in the reflected signal amplitude profile 9 can be the 2^{nd} or 3^{rd} reflection between the pulse-echo ranging system 100 surface of the target 16.

The inventor recognized that by using energy instead of the peak to determine where the first peak will be, the problem of not being able to identify the actual first peak can be avoided. While the peaks can become unrecognizable when the reflected signal shape may become distorted, the behaviour of the energy contained within the signal behaves in a predictable pattern that facilitates the accurate determination of the peak.

Discussion of the method for determining the distance between the pulse-echo ranging system 100 and the target 16 is made with reference to FIGS. 2-5.

FIG. 2 sets forth the flow chart setting forth the method for determining the distance. In step 102 the transmitter 10 transmits a signal 11 to the target 16. The signal 11 can be an ultrasonic signal, a radar signal or a microwave signal. In step 104, reflected signals 13 are received at the receiver 12.

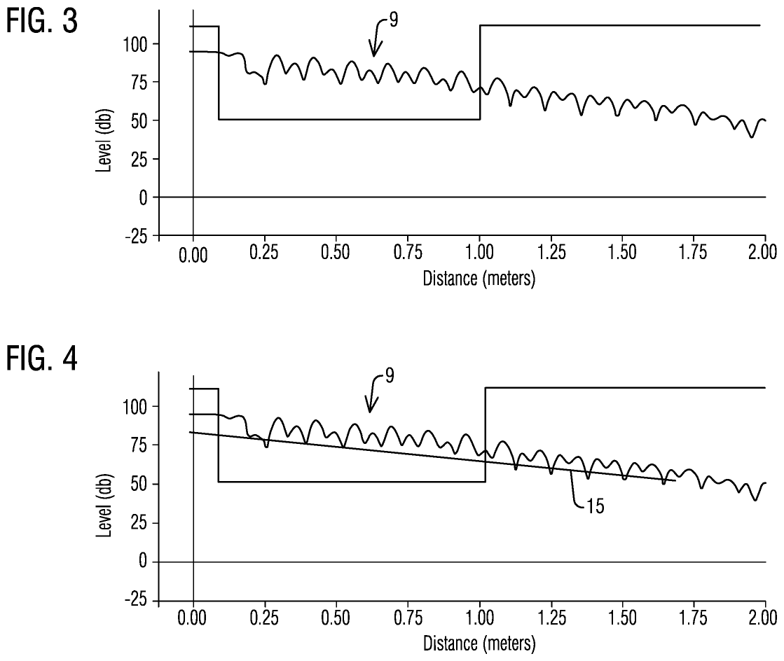

In step 106, a signal processor 14 takes the reflected signal data and forms a reflected signal amplitude profile 9. FIG. 3 shows the display of the reflected signal amplitude profile 9 that is formed from the reflected signal data.

In step 108, an energy decay trend 15, shown in FIG. 4, is determined from the reflected signal amplitude profile 9. The energy decay depends on various parameters that can change depending on the particular application. For instance the environments in which the pulse-echo ranging system 100 is being employed or the materials of the target 16 can impact the energy decay. Generally the energy decays exponentially. However, by taking the log of the decay in the decibel domain the exponential decay typically seen becomes linear. This simplifies the calculation that is made. Furthermore, the energy decay does not depend on phase information. The energy decay trend 15 can then be determined using reflected signal amplitude profile 9 and shape of the peak represented in the signal amplitude profile 9, also known as the envelope. This can be accomplished by doing a least square fit on the envelope.

In order to further save computational costs, the calculations can be done using every N number of samples taken during the formation of the reflected signal amplitude profile 9. For example, if the reflected signal amplitude profile 9 is composed of 2048 samples then to reduce computational costs 1024 samples can be used. A least square fit can then be performed on the reduced reflected signal amplitude profile 9. The energy decay trend 15 can provide a rough decay of the energy that occurs with the reflected signals 13.

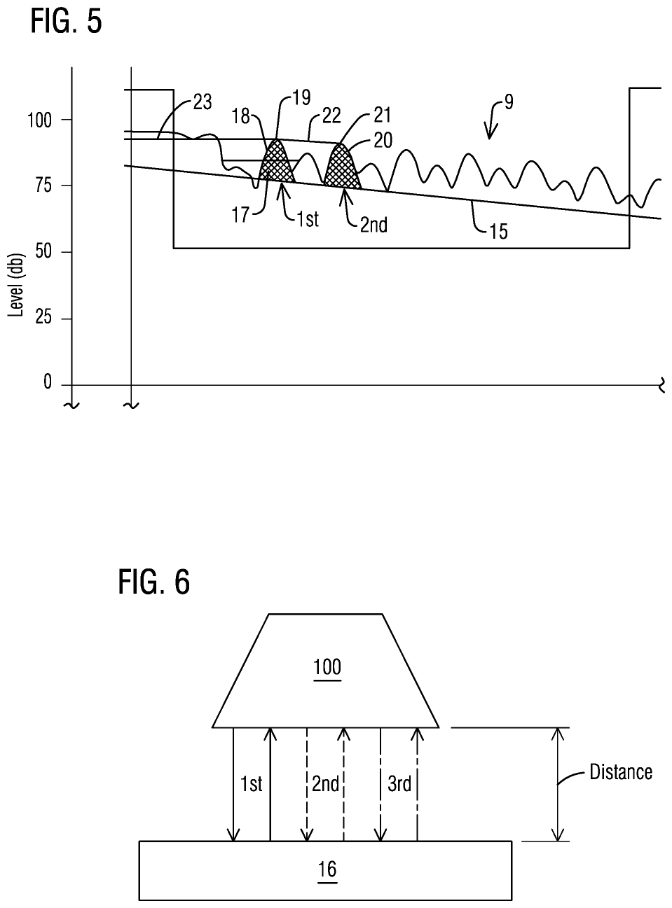

In step 110, a signature 17 of the first reflected signal 18 is obtained. This is shown in FIG. 5. The signature 17 is determined by taking the first determined peak 19 of the first reflected signal 18. The signature 17 can include the height of the first determined peak 19, duration of the signal burst as represented by the reflected signal amplitude profile 9 and the area beneath the first determined peak 19. The area between the first determined peak 19 and the energy decay trend 15 as represented by the reflected signal amplitude profile 9 can represent the energy of the first reflected signal 18. This generally the area on the reflected signal amplitude profile 9 under the envelope and bordered by the energy decal trend 15.

In step 112, the second reflected signal 20 is located using the signature 17 of the first reflected signal 18. This is accomplished by comparing the signature 17 to the reflected signals 13 as represented in the reflected signal amplitude profile 9. In FIG. 5 the second reflected signal 20 is indicated by the third peak shown. This is the second determined peak 21. This is the reflected signal that is most similar to the first reflected signal 18 that is found on the reflected signal amplitude profile 9. After determining the second reflected signal 20 and its second determined peak 21 the search is stopped. The method then progresses to the next step.

The reason that only the first reflected signal 18 and the second reflected signal 20 are used is that these signals are the only signals that are needed in order to meet the needs of determining the distance to the target 16. Furthermore, in environments which cause difficulties in measuring, such as with product foaming or in cold temperatures, only two reflected signals are typically visible.

In step 114, a first distance to the target 16 is determined by using a peak distance 22. The peak distance 22 is the distance between the first determined peak 19 to the second determined peak 21. The peak distance 22 is roughly equal to the distance to the target 16.

FIG. 6 is a diagram that helps to illustrate why the peak distance 22 between the first determined peak 19 and the second determined peak 21 is roughly equal to the distance to the target 16. The pulse-echo ranging system 100 fires a pulse (the signal 11) at the target 16 which is reflected by the target 16 back to the pulse-echo ranging system, this is the first reflected signal in the reflected signal amplitude profile 9. Part of the reflected signal 11 will be reflected by the surface of the pulse-echo ranging system 100 towards the target 16 again, generating a second reflected signal, and again for the third reflected signal. These are label 1^{st}, 2^{nd} and 3^{rd} in the drawings. The difference between two adjacent reflected signals is roughly the distance to the target 16.

Detecting the second reflected signal 20 using the signature 17 and via the use of energy instead of solely the peak is more accommodating of errors that occur due to the disturbance on the echo shape In the event that only the peaks are used there is a risk that use of the wrong peak will result in inaccurate measurements of the distance. Using the signature 17 determined from the detection of the first determined peak 19 to locate the second determined peak 21 can be more accurate in the presence of distorted reflected signals 13. Signal distortion can be caused by frequency distortion, transducer imperfection, environmental factors, etc.

While the peak distance 22 provides a rough distance to the target 16 it is not necessarily the most accurate measurement of the distance. In order to refine the measurement taken in step 114 and increase its accuracy the information garnered about the first determined peak 19 will be used.

During the measurement process the detection of the first reflected signal 18 can typically be detected with ease using conventional algorithms and methods. However, the first reflected signal 18 may not be the primary reflected signal but in fact be the secondary or tertiary reflected signal. In the event that the actual primary reflected signal is not being detected then the distance may be off by a factor of two or three.

In step 118 a multiplier factor is determined for the first reflected signal 18. The multiplier factor is determined by first taking the determined peak distance 22 (as determined in step 114). The determined peak distance 22 is the first distance to the target 16. Another distance to the target 16 is determined using the first determined peak 19.

The distance measured from the first determined peak 19 to the target 16 is taken and as discussed above may not reflect the actual distance to the target 16. The distance from the first determined peak 19 to the target 16 is then divided by the first determined distance to the target 16. The result of this division product is then rounded to the nearest integer. This results in the multiplier factor.

In step 116, the multiplier factor is then applied to the distance from the first determined peak 19 to the target 16 in order to obtain a second distance to the target 16. This results in an accurate determination of the distance to the target 16. An example of this is provided below.

In this example, the results of step 114 obtain a first distance to the target 16 of 48 mm. The distance from the first determined peak 19 to the target 16 is determined to be 104 mm. This indicates that the first determined peak 19 is not the primary reflected signal and instead is most likely the secondary reflected signal (the primary reflected signal has been obscured due to the ringing down). The value 104 is divided by 48, which results in a number of 2.16. This number is rounded to the nearest integer in order to obtain the multiplier factor. In this instance the multiplier factor will be 2. This number is then used to divide the number 104 mm in order to obtain a value of 52 mm. 52 mm is the second distance to the target 16 determined and is more accurate than the first distance to the target 16 determined in step 112. However the first distance to the target 16 is able to correct errors that may be caused by misidentifying what is the primary peak.

The multiplier factor is also used because the pulse-echo ranging system 100 is calibrated using peak detection. The calibration of the pulse-echo ranging system 100 includes an offset distance (determined during the calibration) that is not present in the distance between two reflected signals 13. Additionally, even when the shapes of the reflected signals 13 are distorted the strongest peaks are usually able to be detected.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

1.-19. (canceled)

20. A method for determining distance between an apparatus and a target comprising;
transmitting signals to the target from a transmitter of the apparatus;
receiving reflected signals at a receiver of the apparatus,
forming a reflected signal amplitude profile from the reflected signals;
determining an energy decay trend from the reflected signal amplitude profile;
obtaining a signature of a first reflected signal, wherein the signature of the first reflected signal is determined using the energy decay trend;
locating a second reflected signal using the signature of the first reflected signal; and
determining a first distance to the target by using a peak distance between a first determined peak and a second determined peak,
wherein the signature of the first reflected signal includes height of the first determined peak, duration of the first reflected signal burst and the area of the first reflected signal.

21. The method of claim 20, further comprising determining a multiplier factor for the first reflected signal.

22. The method of claim 21, wherein the step of determining the multiplier factor for the first reflected signal uses the determined first distance to the target.

23. The method of claim 21, further comprising applying the multiplier factor to the first determined peak resulting in a second distance to the target, wherein the second distance to the target is more accurate than the first distance to the target.

24. The method of claim 20, wherein the energy decay trend is linear.

25. The method of claim 20, wherein the energy decay trend is determined using a least square fit.

26. An apparatus for determining distance to a target comprising;
a transmitter for transmitting signals to the target;
a receiver for receiving reflected signals; and
a processor configured to determine from the reflected signals a reflected signal amplitude profile; wherein the processor determines an energy decay trend from the reflected signal amplitude profile; wherein the processor obtains a signature of a first reflected signal, wherein the signature of the first reflected signal is determined using the energy decay trend; wherein the processor locates a second reflected signal using the signature of the first reflected signal; wherein the processor determines a first distance to the target by using a peak distance between a first determined peak and a second determined peak, wherein the signature of the first reflected signal includes height of the first determined peak, duration of the first reflected signal burst and the area of the first reflected signal.

27. The apparatus of claim 26, wherein the processor is configured to determine a multiplier factor for the first reflected signal.

28. The apparatus of claim 27, wherein the processor is configured to use the first determined distance to the target to determine the multiplier factor.

29. The apparatus of claim 27, wherein the processor is configured to apply the multiplier factor to the first determined peak to determine a second distance to the target, wherein the second distance to the target is more accurate than the first distance to the target.

30. The apparatus of claim 26, wherein the energy decay trend is linear.

31. The apparatus of claim 26, wherein the energy decay trend is determined using a least square fit.

32. A method for determining distance between an apparatus and a target comprising;
transmitting signals to the target from a transmitter of the apparatus;
receiving reflected signals at a receiver of the apparatus,
forming a reflected signal amplitude profile from the reflected signals;
determining an energy decay trend of the first reflected signal from the reflected signal amplitude profile;
obtaining a signature of a first reflected signal, wherein the signature of the first reflected signal is determined using the energy decay trend;
locating a second reflected signal using the signature of the first signal;
determining a first distance to the target by using a peak distance between a first determined peak and a second determined peak;
determining a multiplier factor for the first reflected signal using the determined first distance to the target; and
applying the determined multiplier factor to the first determined peak to obtain a second distance to the target, wherein the signature of the first reflected signal includes height of the first determined peak, duration of the first reflected signal burst and the area of the first reflected signal.

33. The method of claim 32, wherein the second distance to the target is more accurate than the first distance to the target.

34. The method of claim 32, wherein the energy decay trend is linear.

35. The method of claim 26, wherein the energy decay trend is determined using a least square fit.
